(19) United States
(12) Patent Application Publication
(10) Pub. No.: US 2005/0008316 A1
(43) Pub. Date: Jan. 13, 2005

(54) Optical waveguide amplifier

(76) Inventor: Aydin Yeniay, Wayne, PA (US)

Correspondence Address: Min, Hsieh & Hack LLP;c/o PortfolioIP, P.O. Box 52050, Minneapolis, MN, 55402, US

(21) Appl. No.: 10/835,437

(22) Filed: Apr. 30, 2004

Related U.S. Application Data
(60) Provisional application No. 60/467,143, filed on May 2, 2003.

(51) Int. Cl. G02B 6/10

(52) U.S. Cl. 385/129

(57) ABSTRACT

Waveguide amplifiers having high gain dynamical range, methods for amplifying optical signals, and methods for fabricating wave guide amplifiers are provided. The waveguide amplifiers include a substrate, lower cladding, upper cladding, and a core having a varying cross-section.

### CROSS-REFERENCE TO RELATED APPLICATIONS

The present application claims the benefit of U.S. Provisional Patent Application Ser. No. 60/467,143 filed May 2, 2003, and is incorporated by reference in its entirety herein.

### TECHNICAL FIELD

The invention generally relates to optical amplifiers, and more particularly, to optical waveguide amplifier configurations having high gain dynamical range.

### BACKGROUND

Optical waveguide amplifiers have been attracting great interest because of their promising integration capability with other passive and active optical components. Further, waveguide amplifiers can be realized at a low cost, be multi-functional, and be combined with advanced integrated light circuits. A conventional waveguide amplifier 100, shown in FIG. 1, includes a substrate 10, a lower cladding layer 20, a core 30, and an upper cladding layer 40. In conventional waveguide amplifier 100, the cross-section of core 30 and the numerical aperture (NA) are constant.

In standard operation, a weak optical signal is generally coupled into waveguide amplifier 100 from a single mode optical fiber. Amplification is accomplished by stimulated emission of active ions (e.g., Erbium, Yitterbium, Nd, Cr, etc.) in core 30. The active ions are excited by an optical pump at a suitable wavelength. The amplified signal is then coupled out of the waveguide amplifier into another single mode fiber. For a given set of material parameters, an optimum small signal gain can be achieved with small core sizes, i.e., less than 2 μm. High power signal gain can be achieved with larger core sizes, i.e., larger than 2 μm. However, because the material and waveguide properties of conventional waveguide amplifiers are constant throughout the medium, conventional waveguide amplifiers are suitable for only a limited range of input signal power values. This results in low gain dynamic range.

Thus, there is a need to overcome these and other problems of the prior art and to provide waveguide amplifiers that enhance amplifier performance of both small signal and high power values.

### SUMMARY OF THE INVENTION

According to various embodiments, there is provided a waveguide amplifier comprising a substrate and a lower cladding disposed on the substrate. The waveguide amplifier further comprises a core disposed on the lower cladding, wherein a core cross-section varies along a length of the core and an upper cladding disposed on the lower cladding and the core.

According to various embodiments, there is further provided a wave guide amplifier comprising a substrate, a lower cladding disposed on the substrate, a core disposed on the lower cladding, and an upper cladding disposed on the lower cladding and the core. The core comprises a first section, wherein a cross-section of the first section decreases continuously from a first end of the first section to a second end of the first section. The core further comprises a second section, wherein a cross-section of the second section increases continuously from a first end of the second section to a second end of the second section. The core further comprises a third curved section, wherein the third curved has a constant cross-section, a first end of the third curved section adjacent the second end of the first section and a second end of the third section adjacent the first end of the second section.

Also according to various embodiments, there are provided methods for making a waveguide amplifier comprising providing a substrate and depositing a lower cladding layer on the substrate. A core layer is deposited on the lower cladding layer and a shadow photomask is deposited on the core layer. The shadow photomask is exposed to ultraviolet light. The core layer is etched to form a core comprising a varying cross-section and to expose a portion of the lower cladding. An upper cladding layer is then deposited on the core and the exposed portion of the lower cladding.

According to various embodiments, a method for amplifying an optical signal is provided. The method comprises coupling the optical signal from a first optical fiber into a core of a waveguide amplifier, wherein the core of the waveguide amplifier comprises a varying cross-section to form a range of mode-field regions. The optical signal is amplified by stimulated emission as the optical signal propagates through the mode-field regions. The optical signal is then coupled from the core of the waveguide amplifier into a second optical fiber.

According to various embodiments, a method for making a waveguide amplifier is provided. The method comprises lithographically fabricating a master including a core shape having a varying dimension. The master is used to form a stamper, the stamper including a negative of the core shape. A lower cladding layer and a core layer are provided, and the stamper is used to form a core having a varying dimension from the core layer. A portion of the lower cladding is exposed and an upper cladding layer is deposited on the core and the exposed portion of the lower cladding layer.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings,

FIG. 1 schematically depicts a conventional waveguide amplifier.

FIG. 2a schematically depicts a waveguide amplifier in accordance with an exemplary embodiment of the invention.

FIG. 2b depicts a side view of a waveguide amplifier in accordance with an exemplary embodiment of the invention.

FIG. 3a schematically depicts a waveguide amplifier in accordance with an exemplary embodiment of the invention.

FIG. 3b depicts a top view of a waveguide amplifier in accordance with an exemplary embodiment of the invention.

FIG. 3c depicts a side view of a waveguide amplifier in accordance with an exemplary embodiment of the invention.

FIG. 4a schematically depicts a waveguide amplifier in accordance with an exemplary embodiment of the invention.

FIG. 4b depicts a top view of a waveguide amplifier in accordance with an exemplary embodiment of the invention.

FIG. 4c depicts a side view of a waveguide amplifier in accordance with an exemplary embodiment of the invention.

FIG. 5a schematically depicts a waveguide amplifier in accordance with an exemplary embodiment of the invention.

FIG. 5b depicts a top view of a waveguide amplifier in accordance with an exemplary embodiment of the invention.

FIG. 5c depicts a side view of a waveguide amplifier in accordance with an exemplary embodiment of the invention.

FIG. 6a schematically depicts a waveguide amplifier in accordance with an exemplary embodiment of the invention.

FIG. 6b depicts a top view of a waveguide amplifier in accordance with an exemplary embodiment of the invention.

FIG. 6c depicts a side view of a waveguide amplifier in accordance with an exemplary embodiment of the invention.

FIG. 7 is a graph showing simulation results of convention waveguide amplifiers and waveguide amplifiers in accordance with an exemplary embodiment of the invention.

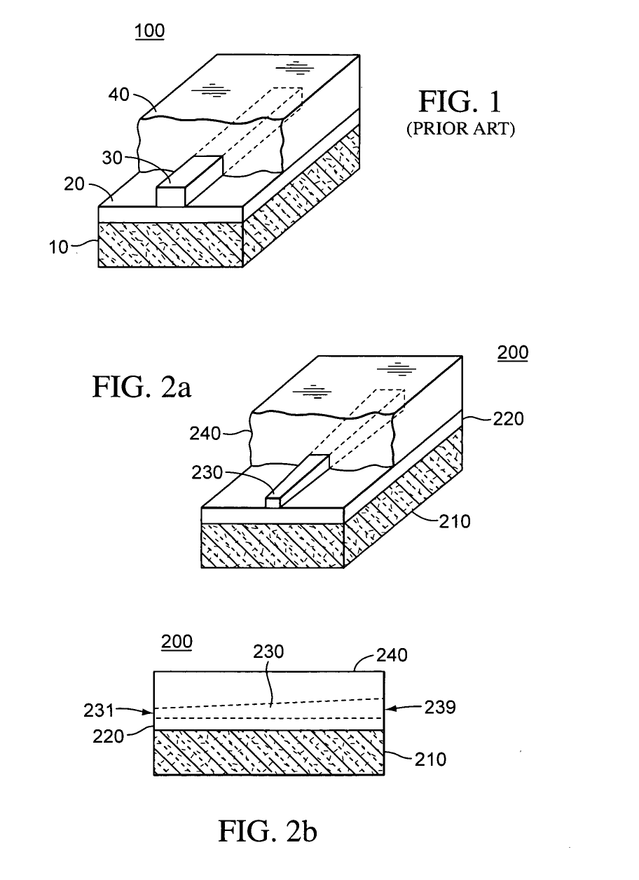

### DETAILED DESCRIPTION

In the following description, reference is made to the accompanying drawings that form a part thereof, and in which is shown by way of illustration a specific exemplary embodiment in which the invention may be practiced. This embodiment is described in sufficient detail to enable those skilled in the art to practice the invention and it is to be understood that other embodiments may be utilized and that changes may be made without departing from the scope of the present invention. The following description is, therefore, not to be taken in a limited sense.

FIGS. 2-8 disclose waveguide amplifier structures, methods of use, and methods of manufacture, in accordance with an exemplary embodiment of the present invention. The exemplary waveguide amplifier structures can propagate an input optical signal. Further, the exemplary waveguide amplifiers can amplify the input optical signal in a range of mode-field regions. The amplification can enhance performance in both small signal and high input power regimes. As used herein, the term “mode field region” or “mode field diameter” refers to a measure of radial intensity distribution of propagating light in a waveguide and means the distance from the waveguide center at which intensity drops to a value of 1/e²=0.135 of a peak value, where e is Euler's number (also known as Napier's constant).

According to various embodiments, as shown in FIGS. 2a-2b, waveguide amplifier 200 can include a substrate 210, a lower cladding 220, a core 230, and an upper cladding 240. Lower cladding 220 is disposed on substrate 210 and core 230 is disposed on a portion of lower cladding 220. Upper cladding 240 is disposed on core 230 and on portions of lower cladding 220 not covered by core 230.

Substrate 210 provides a relatively flat platform for forming subsequent layers. Further, the polarization and thermal properties of the resulting waveguide amplifier can be adjusted based on a difference between a coefficient of thermal expansion (CTE) of the material of substrate 210 and a CTE of the materials of waveguide amplifier 200. In certain embodiments, the material of substrate 210 can be a conventional material, such as, for example, silicon, glass, or polymer.

As shown in FIGS. 2a and 2b, core 230 can have a cross-section, for example comprising a width and/or a height, that continuously increases from an input end 231 to an output end 239. In various embodiments, core 230 can have a width and a height that continuously increases along a length of waveguide amplifier 200 from input end 231 to output end 239.

The difference in the refractive index (An) between the material of core 230 and the material of the cladding layers (lower cladding 220 and upper cladding 240) confines an optical signal (i.e., light) inside of core 230. Core 230, lower cladding 220, and upper cladding 240 can be an optical material, such as, for example, glass or polymer.

Generally, lower cladding 220 can be deposited on substrate 210 by spin coating, dipping, spraying, molding, stamping, nanoreplication, physical vapor deposition, chemical vapor deposition, sputtering, or other methods known in the art. In various embodiments, substrate 210 can have a coefficient of thermal expansion similar to the coefficient of thermal expansion of lower cladding layer 220. A core layer can then be deposited on lower cladding 220 by spin coating, dipping, spraying, molding, stamping, nanoreplication, physical vapor deposition, chemical vapor deposition, sputtering, or other methods known in the art. The width and/or height of core 230 can then be varied. In various embodiments, the width and/or height of core 230 can be varied using a shadow photomask. For example, the shadow photomask can be formed by depositing a photoresist layer on the core layer. A desired pattern of core 230, including variations in width, can be obtained by applying ultraviolet (UV) light through the shadow photomask to expose the photoresist. The shadow photomask can also affect the photoresist exposed to UV light so as to obtain height variations of the core. In various embodiments, the UV transmission profile of the shadow photomask can be linearly varied across a predetermined length to obtain the continuously increasing height across that length of core 230. The shape of core 230 can be formed on a portion of lower cladding 220 by wet or dry etching techniques, such as, reactive ion etching (RIE). In certain embodiments, the height of core 230 follows the photoresist layer thickness pattern. Upper cladding 240 can then be deposited on core 230 and on exposed portions of lower cladding 220 by spin coating, dipping, spraying, physical vapor deposition, chemical vapor deposition, sputtering, or other methods known in the art.

According to various embodiments, waveguide amplifier 200 can be fabricated via nanoreplication process, which utilizes, a master, a stamper, and replicas. The master can be fabricated by lithographic methods described herein (e.g., via shadow mask) on various substrates including but not limited to silicon, glass, and quartz. Once the master with a waveguide structure is generated, it can be used to form a stamper. The stamper is cured via, including but not limited to, ultra violet (UV) light curing and hot embossing processes. Furthermore, an appropriate substrate can also be utilized as a lower cladding 220 to reduce the fabrication steps. The stamper is then used to form core 230 from lower cladding 220 having a core layer on lower cladding 220. Upper cladding 240 can be formed on core 230 and lower cladding 220 by, for example, spin coating, dipping, spraying, physical vapor deposition, chemical vapor deposition, sputtering processes, or other methods known in the art. The formed waveguide amplifiers are then cured and the pattern features permanently fixed.

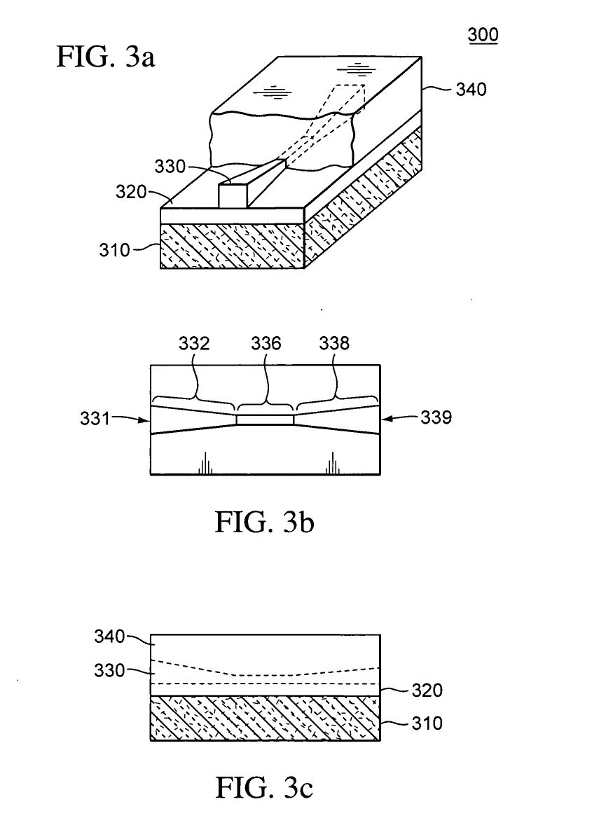

According to various embodiments, as shown in FIGS. 3a-3c, waveguide amplifier 300 can include a substrate 310, a lower cladding 320, a core 330, and an upper cladding 340. As depicted in FIG. 3a, core 330 can include a first section 332, a second section 336, and a third section 338. First section 332 can have a cross-section that continuously decreases from an input end 331 to an end adjacent second section 336. FIG. 3b, which depicts a top view of waveguide amplifier 300, shows a width of first section 332 that continuously decrease from first end 331 to the end adjacent second section 336. Further, as shown in FIG. 3c, which is a side view of waveguide amplifier 300, the height of first section 331 can also continuously decrease from first end 331 to the end adjacent second section 336.

In various embodiments, second section 336 can have a constant cross-section. As shown in FIG. 3b, a width of second section 336 can be constant. Further, FIG. 3c, shows the height of second section 336 can be constant.

In various embodiments, third section 338 can have a width that continuously increases from an end adjacent second section 336 to an output end 339, as shown in FIG. 3b. Third section 338 can also have a continuously increasing height from the end adjacent second section 336 to the output end 339, as shown in FIG. 3c.

The structure, such as the shape, of core 330 can be formed by the shadow photomask technique described herein. The exemplary three section configuration can be formed by a shadow photomask having a UV light transmission profile consistent with the shape of the core height profile shown in FIG. 3c. In various embodiments, a length of each core section can be different. Moreover, in various embodiments, the variation in height of first section 332 can differ from the variation in height of second section 336 and/or third section 338. In addition, the structure of waveguide amplifier can be fabricated by the nanoreplication process described herein.

Propagating the input signal in various core structures having different lengths, widths, and/or heights, can change the mode field diameter and the confinement of the signal in the waveguide structure. A waveguide design using embodiments disclosed herein can be beneficial for high An waveguide amplifiers. For example, these structures can take advantage of both small and large core amplifier characteristics, as well as match the mode-field diameters to the single mode fiber at the interfaces. Further, efficient coupling to a single mode fiber can be accomplished by matching the mode field diameters of waveguide 300 to an input single mode fiber and an output single mode fiber (not shown). Thus, the cross-section of first section 332 at input end 331, the cross-section of second section 336, the cross-section of third section 338 at output end 339, and the length of each section can be changed to adjust the amplification and the coupling to the single mode fibers. Input and output fibers need not be restricted to single mode fibers but can also include multimode fibers.

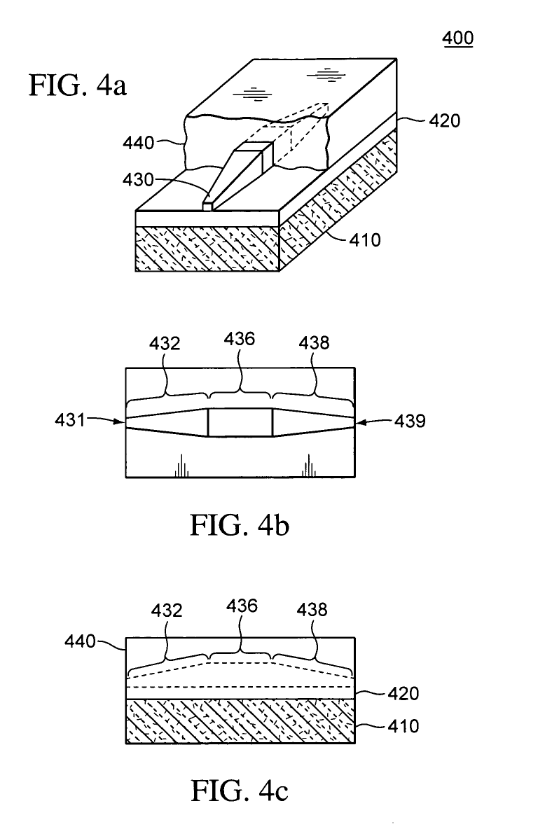

According to various embodiments, as shown in FIGS. 4a-4c, waveguide amplifier 400 can include a substrate 410, a lower cladding 420, a core 430, and an upper cladding 440. As depicted in FIG. 4a, core 430 can include a first section 432, a second section 436, and a third section 438. FIG. 4b, which is a top view of waveguide 400, depicts first section 432 having a cross-section that continuously increases from an input end 431 to an end adjacent second section 436. Further, as shown in FIG. 4c, which is a side view of waveguide amplifier 400, the height of first section 432 can also continuously increase from first end 431 to the end adjacent second section 436.

In various embodiments, second section 436 can have a constant cross-section. As shown in FIG. 4b, the width of second section 436 can be constant. Further, as shown in FIG. 4c, the height of second section 436 can be constant.

In various embodiments, as shown, for example in FIG. 4b, third section 438 can have a width that continuously decreases from an end adjacent second section 436 to an output end 439. Further, as shown in FIG. 4c, the height of third section 438 can further have a continuously decreasing height from the end adjacent second section 436 to the output end 439.

Moreover, as shown in FIG. 4b, third section 438 can have a width that continuously decreases from an end adjacent second section 436 to an output end 439. Third section 438 can further have a continuously decreasing height from the end adjacent second section 436 to the output end 439, as shown in side view FIG. 4c.

The structure of core 430 can be formed by a shadow photomask technique described herein. The exemplary three section configuration can be formed by a shadow photomask having a UV light transmission profile consistent with the shape of the core height profile shown in FIG. 4c. In various embodiments, the length, width, and/or height of each core section can be different. In addition, the structure of core 430 can be fabricated via nanoreplication process, as described herein.

Propagating the input signal in different core structures with different lengths, widths, and/or heights can change the signal in terms of its mode field diameter and its confinement in the waveguide structure. A waveguide design using this type of structure can be beneficial for low An waveguide amplifiers. For example, these structures can take advantage of both small and large core amplifier characteristics, as well as match the mode-field diameters to the single mode fiber at the interfaces. The cross-section of first section 432 at input end 431, the cross-section of second section 436, the cross-section of third section 438 at output end 439, and the length of each section can be changed to adjust the amplification and the coupling to the single mode fibers.

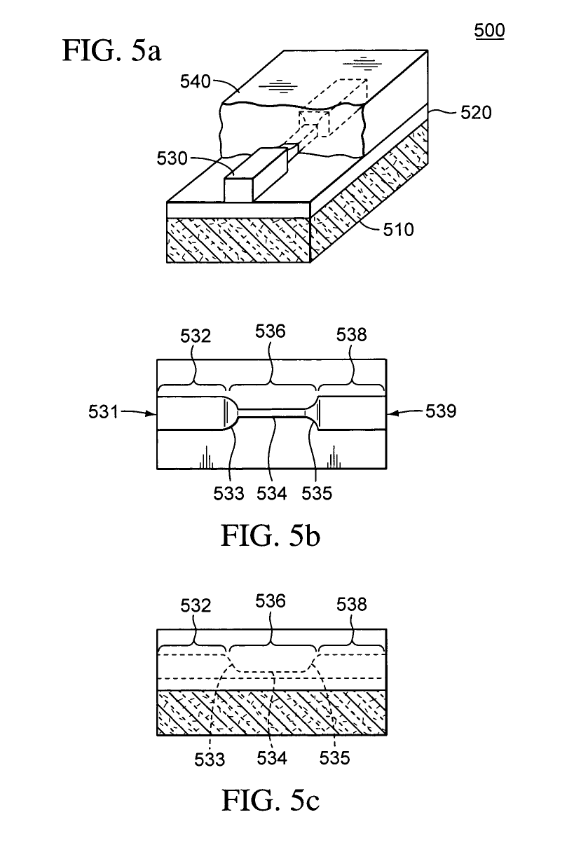

According to various embodiments, as shown in FIGS. 5a-5c, waveguide amplifier 500 can include a substrate 510, a lower cladding 520, a core 530, and an upper cladding 540. As depicted in FIG. 5a, core 530 can include a first section 532, a second section 536, and a third section 538. First section 532 can have a constant cross-section. Third section 538 can also have a constant cross-section.

Referring to FIGS. 5b and 5c, second section 536 can include a middle portion 534 having a constant cross-section that can be smaller than the cross-sections of first section 532 and third section 538. Second section 536 can further include a first end portion 533 adjacent to first section 532. As shown in FIG. 5b, which is a top view of waveguide amplifier 500, a cross-section of first end portion 533 decreases from a cross-section similar to first section 532 to a cross-section similar to middle portion 534. To reduce mode field mismatch losses and scattering loss that can result from a sudden decrease in core size, a gradual decrease in core diameter can be used. In various embodiments, first end portion 533 can have a concave shape to gradually change the mode size of the light. The concave shape can be formed using two photomasks by methods known to one of skill in the art. Second section 536 can further include a second end portion 535 adjacent to third section 538. As shown in FIG. 5b, a cross-section of second end portion 535 increases from a cross-section similar to middle portion 534 to a cross-section similar to third section 538. To reduce mode field mismatch losses and scattering loss that can result from a sudden increase in core size, a gradual increase in core diameter can be used. In various embodiments, second end portion 535 can have a convex shape to gradually change the mode size of the light. The convex shape can be formed using two photomasks by methods known to one of skill in the art.

Fabrication of waveguide amplifiers can be accomplished using methods similar to those disclosed herein. However, in certain embodiments, a shadow photomask may not be required, and an addition process step can be used. In particular, a separate photomask and a reactive ion etch process can be used for each core height. Similarly, in nanoreplication fabrication process, masters can be fabricated via similar method without a shadow mask on substrates of, for example, silicon, glass, and quartz. Once a master with a waveguide structure is generated, it can be used to form hundreds of stampers via, including but not limited to, ultra violet (UV) light curing and hot embossing processes.

For example, a first photomask can provide the greater core height of first section 532 and third section 538, in an embodiment where first section 532 and third section 538 have a similar core height. A second photomask can then be provided to allow etching of core 530 so that the height of second section 536 is lower than the height of first section 532 and third section 538. In various embodiments, a more complex structure can be made with additional layers by using additional photomasks and etching processes. Similarly, in nanoreplication fabrication processes, masters can be fabricated via similar methods without a shadow mask on substrates, such as, for example, silicon, glass, and quartz. Once a master with a waveguide structure is generated, it can be used to form hundreds of stampers via, including but not limited to, ultra violet (UV) light curing and hot embossing processes.

Propagating the input signal in waveguide amplifier 500 having various core structures with different lengths, widths, and/or heights, can change the mode field diameter and the confinement of the signal in the waveguide structure. A waveguide design using embodiments disclosed herein can be beneficial for low Δn waveguide amplifiers by taking advantage of both small and large core amplifier characteristics, as well as matching the mode-field diameters to the single mode fiber at the interfaces. The cross-section of first section 532, the cross-section of second section 536, the cross-section of third section 538, and the length of each section can be changed to adjust the amplification and the coupling to the single mode fibers.

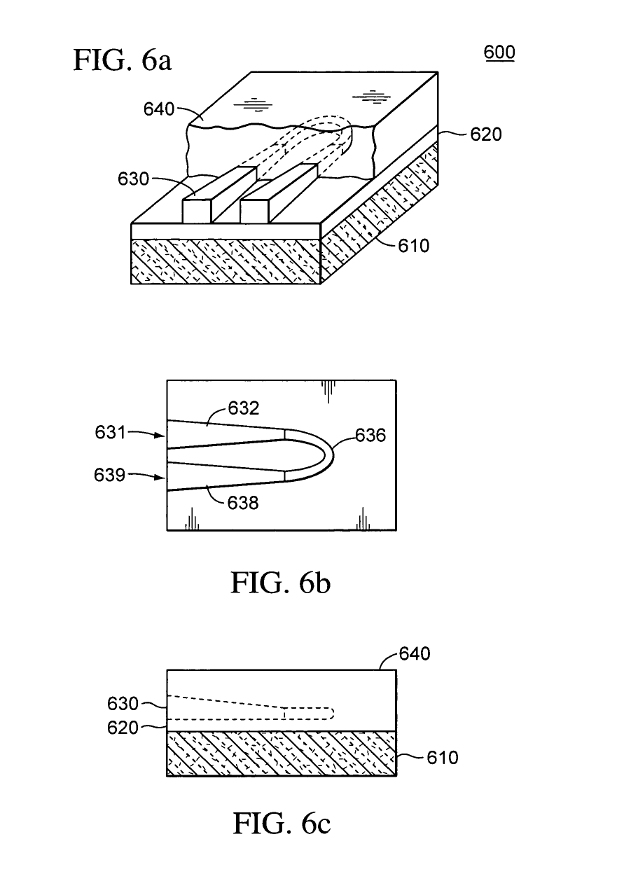

According to various embodiments, as shown in FIGS. 6a-6c, waveguide amplifier 600 can include a substrate 610, a lower cladding 620, a core 630, and an upper cladding 640. As depicted in FIG. 6a, core 630 can include a first section 632, a second section 636, and a third section 638. First section 632 can have cross-section that continuously decreases from an input end 531 to an end adjacent to second section 636. Third section 638 can have cross-section that continuously increases from an end adjacent to second section 636 to an output end 639. Second section 636 can have a constant cross-section.

Referring to the top view of waveguide amplifier 600 as shown in FIG. 6b, first section 632 can have a width that increases from input end 631 to an end adjacent to second section 636. As shown in side view of waveguide amplifier 600 in FIG. 6c, first section 632 can have a height that decreases from input end 631 to an end adjacent to section 636.

Referring to FIGS. 6b and 6c, second section can be curved and can have a constant height. Referring to the top view of waveguide amplifier 600 in FIG. 6b, third section 638 can have a width that increases from an end adjacent to second section 636 to input end 631. As shown in side view of waveguide amplifier 600 in FIG. 6c, third section 638 can have a height that increases from an end adjacent to second section 636 to output end 639.

Fabrication of waveguide amplifier 600 can be accomplished using methods similar to those disclosed herein. In particular, the waveguide amplifier structure can be made using a shadow photomask having a UV light transmission profile similar to a height of core 630 as shown in FIG. 6c. In various embodiments, a more complex structure can be made with additional layers by using additional photomasks and etching processes. Because the input signal propagates within waveguide amplifier 600 in various core structures with different lengths, widths, and/or heights, the signal will be changed in terms of its mode field diameter and its confinement in the waveguide structure. A waveguide design using embodiments disclosed herein can be beneficial for high An waveguide amplifiers by taking advantage of both small and large core amplifier characteristics, as well as matching the mode-field diameters to the single mode fiber at the interfaces. The cross-section of first section 632 at input end 631, the cross-section of second section 636, the cross-section of third section 638 at output end 639, and the length of each section can be changed to adjust the amplification and the coupling to the single mode and/or multimode fibers. In addition, waveguide amplifier can be fabricated via nanoreplication processes, as disclosed herein.

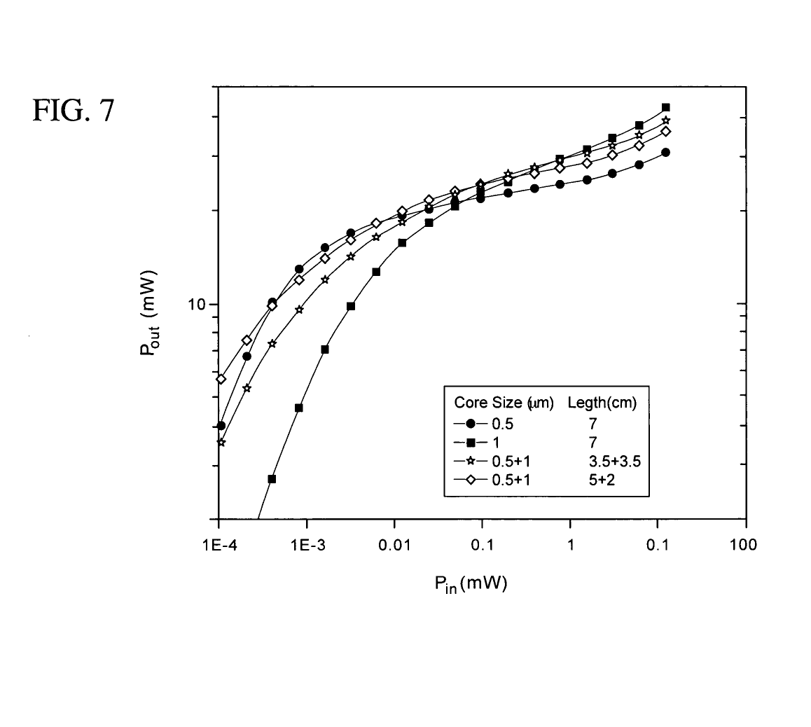

FIG. 7 shows an exemplary simulated amplifier performance for four waveguide amplifiers. The performance of first conventional waveguide amplifier having a core height of 0.5 μm, a core width of 0.5 μm, and a core length of 7 cm is shown in FIG. 7 by the circles. The performance of second conventional waveguide amplifier having a core height of 1.0 μm, a core width of 1.0 μm, and a core length of 7 cm is shown in FIG. 7 by the squares. As shown by FIG. 7, the conventional waveguide amplifier having the larger core size of 1.0 μm×1.0 μm×7 cm provides lower efficiency in a small signal regime (Pin<0.1 mW) and a higher efficiency in a saturation regime (Pin>1 mW) compared to the conventional waveguide having the smaller core size of 0.5 μm×0.5 μm×7 cm.

FIG. 7 further shows simulated amplifier performance for two exemplary waveguide amplifiers having a core with two sections that increases in size. A first exemplary wave guide has a first core section of 0.5 μm height, 0.5 μm width, and 3.5 cm height and a second core section of 1.0 μm height, 1.0 μm width, and 3.5 cm length, shown in FIG. 7 by the stars. A second exemplary wave guide has a first core section of 0.5 μm height, 0.5 μm width, and 5.0 cm height and a second core section of 1.0 μm height, 1.0 μm width, and 2.0 cm length, shown in FIG. 7 by the stars. As shown in FIG. 7, the two exemplary waveguide amplifiers with varying core sizes provide a higher dynamic range in input power values by performing better in both the small signal and the saturation regime.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered exemplary only, with a true scope of the invention being indicated by the following claims.

1. A waveguide amplifier comprising:
a substrate;
a lower cladding disposed on the substrate;
a core disposed on the lower cladding, wherein a core cross-section varies along a length of the core; and
an upper cladding disposed on the lower cladding and the core.

2. The waveguide amplifier of claim 1, wherein the core cross-section increases continuously from a first end of the core to a second end of the core.

3. The waveguide amplifier of claim 1, wherein the core comprises:
a first section, wherein a cross-section of the first section decreases continuously from a first end of the first section to a second end of the first section;
a second section, wherein a cross-section of the second section is constant from the first end of the second section to the second end of the second section, the first end of the second section being adjacent to the second end of the first section; and
a third section, wherein a cross-section of the third section increases continuously from a first end to a second end, the first end of the third section being adjacent to the second end of the second section.

4. The waveguide amplifier of claim 3, wherein a length of the first section is different than a length of the second section.

5. The waveguide amplifier of claim 4, wherein a length of the first section is different than a length of the third section.

6. The waveguide amplifier of claim 1, wherein the core comprises:
a first section, wherein a cross-section of the first section increases continuously from a first end of the first section to a second end of the first section;
a second section, wherein a cross-section of the second section is constant from the first end of the second section to the second end of the second section, the first end of the second section being adjacent to the second end of the first section; and
a third section, wherein a cross-section of the third section decreases continuously from a first end to a second end, the first end of the third section being adjacent to the second end of the second section.

7. The waveguide amplifier of claim 6, wherein a length of the first section is different than a length of the second section.

8. The waveguide amplifier of claim 7, wherein a length of the first section is different than a length of the third section.

9. The waveguide amplifier of claim 1, wherein the core comprises:
a first section, wherein a cross-section of the first section is constant from a first end of the first section to a second end of the first section;
a second section, wherein a cross-section of the second section is constant from a first end of the second section to a second end of the second section; and
a third section disposed between the first section and the second section, comprising
a middle portion have a constant cross-section;
a first end portion comprising a cross-section similar to the cross-section of the second end of the first section that decreases to the cross-section of the middle portion, and
a second end portion comprising a cross-section similar the cross-section of the middle portion that increases to a cross-section similar to the cross-section of the second section.

10. The waveguide amplifier of claim 9, wherein a length of the first section is different than a length of the second section.

11. The waveguide amplifier of claim 10, wherein a length of the first section is different than a length of the third section.

12. A wave guide amplifier comprising:
a substrate;
a lower cladding disposed on the substrate;
a core disposed on the lower cladding, wherein the core comprises
a first section, wherein a cross-section of the first section decreases continuously from a first end of the first section to a second end of the first section,
a second section, wherein a cross-section of the second section increases continuously from a first end of the second section to a second end of the second section, and
a third curved section, wherein the third curved has a constant cross-section, a first end of the third curved section adjacent the second end of the first section and a second end of the third section adjacent the first end of the second section; and
an upper cladding disposed on the lower cladding and the core.

13. The waveguide amplifier of claim 12, wherein a length of the first section is different than a length of the second section.

14. The waveguide amplifier of claim 13, wherein a length of the first section is different than a length of the third section.

15. A method for making a waveguide amplifier comprising:
providing a substrate;
depositing a lower cladding layer on the substrate;
depositing a core layer on the lower cladding layer;
depositing a shadow photomask on the core layer;
exposing the shadow photomask to ultraviolet light;
etching the core layer to form a core comprising a varying cross-section and to expose a portion of the lower cladding;
depositing an upper cladding layer on the core and the exposed portion of the lower cladding.

16. The method of claim 15, wherein exposing the shadow photomask to ultraviolet light further comprises controlling exposure of the shadow photomask to ultraviolet light to form an ultraviolet light transmission profile consistent with a desired core height.

17. The method of claim 16, wherein exposure of the shadow photomask to ultraviolet light varies to form a linear ultraviolet light transmission profile.

18. A method for amplifying an optical signal comprising;
coupling the optical signal from a first optical fiber into a core of a waveguide amplifier, wherein the core of the waveguide amplifier comprises a varying cross-section to form a range of mode-field regions;
amplifying the optical signal by stimulating emission as the optical signal propagates through the mode-field regions; and
coupling the amplified optical signal from the core of the waveguide amplifier into a second optical fiber.

19. The method of claim 18, wherein the range of mode field regions are formed by a continuously increasing core cross-section.

20. The method of claim 18, wherein the range of mode field regions are formed by a core comprising:
a first section, wherein a cross-section of the first section decreases continuously from a first end of the first section to a second end of the first section;
a second section, wherein a cross-section of the second section is constant from the first end of the second section to the second end of the second section, the first end of the second section being adjacent to the second end of the first section; and
a third section, wherein a cross-section of the third section increases continuously from a first end to a second end, the first end of the third section being adjacent to the second end of the second section.

21. The method of claim 18, wherein the range of mode field regions are formed by a core comprising:
a first section, wherein a cross-section of the first section increases continuously from a first end of the first section to a second end of the first section;
a second section, wherein a cross-section of the second section is constant from the first end of the second section to the second end of the second section, the first end of the second section being adjacent to the second end of the first section; and
a third section, wherein a cross-section of the third section decreases continuously from a first end to a second end, the first end of the third section being adjacent to the second end of the second section.

22. The method of claim 18, wherein the range of mode field regions are formed by a core comprising:
a first section, wherein a cross-section of the first section is constant from a first end of the first section to a second end of the first section;
a second section, wherein a cross-section of the second section is constant from a first end of the second section to a second end of the second section; and
a third section disposed between the first section and the second section, comprising,
a middle portion have a constant cross-section;
a first end portion comprising a cross-section similar to the cross-section of the second end of the first section that decreases to the cross-section of the middle portion, and
a second end portion comprising a cross-section similar the cross-section of the middle portion that increases to a cross-section similar to the cross-section of the second section.

23. The method of claim 18, wherein the range of mode field regions are formed by a core comprising:
a first section, wherein a cross-section of the first section decreases continuously from a first end of the first section to a second end of the first section,
a second section, wherein a cross-section of the second section increases continuously from a first end of the second section to a second end of the second section, and
a third curved section, wherein the third curved has a constant cross-section, a first end of the third curved section adjacent the second end of the first section and a second end of the third section adjacent the first end of the second section.

24. The method of claim 18, wherein at least one of the first optical fiber and the second optical fiber is a single mode optical fiber.

25. The method of claim 18, wherein at least one of the first optical fiber and the second optical fiber is a multi-mode optical fiber.

26. A method of making a waveguide amplifier comprising:
lithographically fabricating a master comprising a core shape having a varying dimension;
using the master to form a stamper, wherein the stamper includes a negative of the core shape;
providing a lower cladding layer and a core layer;
using the stamper to form a core having a varying dimension from the core layer;
exposing a portion of the lower cladding; and
depositing an upper cladding layer on the core and the exposed portion of the lower cladding layer.

27. The method of claim 24, further comprising curing at least the core and the upper cladding layer.

28. The method of claim 24, wherein forming the stamper further comprises curing the stamper by at least one of ultraviolet light and hot embossing.
